(19) United States
(12) Patent Application Publication
(10) Pub. No.: US 2020/0060235 A1
(43) Pub. Date: Feb. 27, 2020

(54) Veterinary and Grooming Collar

(71) Applicant: Bark Bark Club Management LLC, Chicago, IL (US)

(72) Inventors: Patricia Colandrea, Chicago, IL (US); Elizabeth Casterjon, Chicago, IL (US)

(73) Assignee: Bark Bark Club Management LLC

(21) Appl. No.: 16/547,281

(22) Filed: Aug. 21, 2019

Related U.S. Application Data
(60) Provisional application No. 62/720,382, filed on Aug. 21, 2018.

(51) Int. Cl. A01K 15/04

(52) U.S. Cl. CPC A01K 15/04; A01K 27/001

(57) ABSTRACT

A collar that provides a restraint for dogs or other animals from biting the veterinarian or pet groomer when the animal is being examined, treated or groomed. The collar is formed from a rigid yet flexible foam sheet of polyethylene with a recessed portion on one edge that receives the underside of the dog's chin for proper positioning and comfort as it encircles the dog's neck. A fastener at the ends of the foam sheet adjusts the collar to fit the dog's neck and also provides an easy way to attach and remove the collar from around the dog's neck.

### CROSS REFERENCE TO RELATED APPLICATION

This application is based on and claims the priority of U.S. provisional patent application Ser. No. 62/720,382 filed Aug. 21, 2018.

### FIELD OF THE INVENTION

This invention relates to a restraint for dogs or other animals from biting the veterinarian or pet groomer when the animal is being examined, treated or groomed.

### BACKGROUND AND SUMMARY OF THE INVENTION

Various restraints have been used in the past in an effort to keep the veterinarian or pet groomer from being bitten when performing the procedure on the dog. The idea has been to restrain the dog in a stationary position while performing the examination or grooming. One such device is illustrated in U.S. Pat. No. 5,960,746 issued to Salts. This device attaches to a grooming table and uses restraints that secure the animal around the neck and chest. This device is intended to immobilize the pet during the procedure and allow access to the pet so that the procedure can be completed.

Another device is illustrated in U.S Pub. No. US 2009/0071418 A1. This device is a loop restraining device that encircles the dog's neck and is intended to keep the dog from turning his head and biting the veterinarian or pet groomer. However, the device does not adequately restraint the dog from turning his head a sufficient amount to adequately protect the veterinarian or pet groomer. At best it will keep the dog from walking off the examination table.

Another commonly seen device is a cone that is placed around the dog's neck and extends out a distance at least equal to the dog's snout to keep the dog from licking or biting at a wound, sore or rash. However, it does not allow the dog to see the veterinarian or pet groomer when performing the procedure, so it does not help in calming the dog while the procedure is being performed. Another device is a muzzle placed over the dog's nose and mount, but this doesn't keep the dog's head from moving and stresses to the dog making the grooming or veterinary procedure more difficult.

The present invention provides for a rigid foam collar that wraps around the dog's neck. The collar restricts the movement of the dog's head yet allows the dog to still have visual contact with the surrounding area and the veterinarian or groomer. It also allows unrestricted breathing of the dog while the collar is attached. The collar provides a calming environment and keeps the dog from being overly excited during the examination or grooming. This allows the veterinarian or groomer to more quickly perform the examination or grooming as the dog is restrained and does not try to bite the veterinarian or groomer or interfere with the examination or grooming. Also, the collar allows the veterinarian or groomer to have both hands free to perform the procedure. Some of the prior art devices required the person to hold the device or the dog with one hand and only use the free hand.

The collar is formed from a rigid yet flexible foam sheet of polyethylene with an elongated Velcro strip extending out from one end of the foam sheet and a hook fastener on the other end that receives the loop face of the Velcro strip. The Velcro strip allows adjustment of the collar to fit the dog's neck. It also is an easy way to attach and remove the collar from around the dog's neck. There is a recessed portion on the foam sheet that receives the underside of the dog's chin for proper positioning and comfort as it encircles the dog's neck.

### BRIEF DESCRIPTION OF THE DRAWINGS

For a better understanding of the present invention, reference is to be made to the accompanying drawings. It is to be understood that the present invention is not limited to the precise arrangement shown in the drawings as the size of the collar may vary depending on the size of the dog.

FIG. 1 is a side view a dog with the inventive collar around its neck.

FIG. 2 is a top plan view of the animal collar of the present invention.

FIG. 3 is a top perspective view of the animal collar of the present invention.

FIG. 4 is a front view of the animal collar.

FIG. 5 is a right-side view of the collar with an enlarged view of the arcuate encircled portion shown in dotted lines.

FIG. 6 is an enlarged view of the female hook and loop fastener attached to the foam base.

FIG. 7 is a perspective view of the collar when in the folded position around an animal's neck.

FIG. 8 is a right side view of the collar in the folded position.

FIG. 9 is a left side view of the collar in the folded position.

FIG. 10 is a front elevation view of the collar in the folded position.

FIG. 11 is a rear view of the collar in the folded position.

FIG. 12. is a top view of the collar in the folded position.

FIG. 13 is a bottom view of the collar in the folded position.

### DETAILED DESCRIPTION OF THE PREFERRED EMBODIMENT

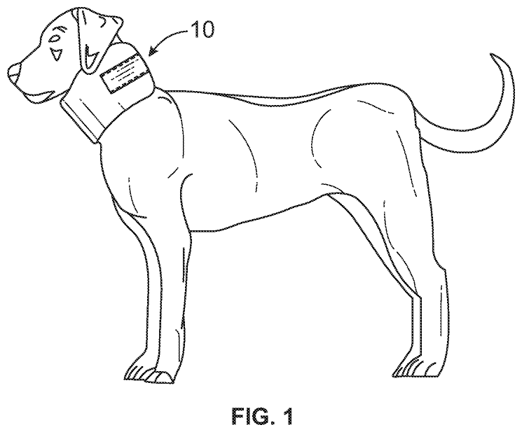

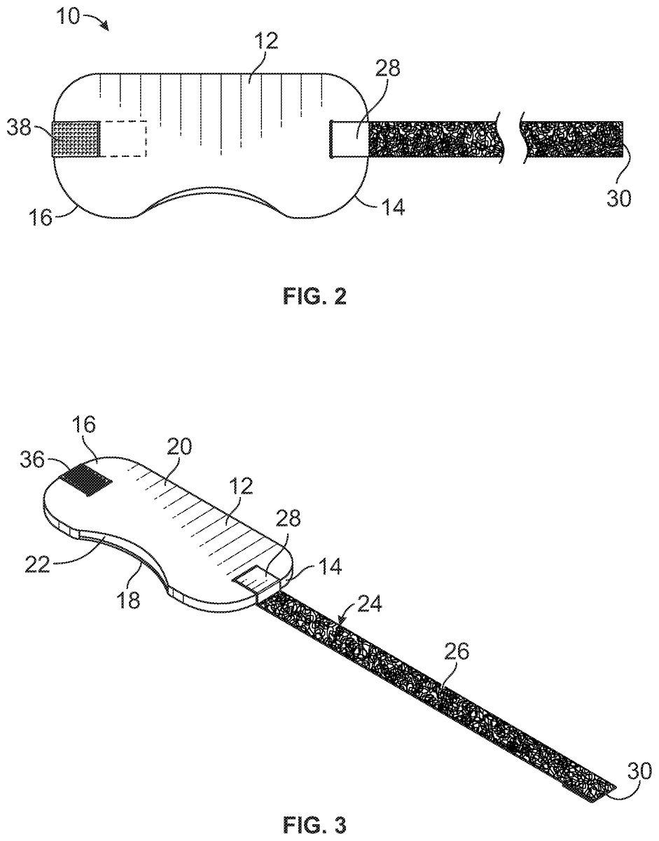

Throughout this application, the reference to a dog, animal or pet is meant to also include any other animal that may be fitted for use with the invention. FIG. 1 illustrates a collar or restraint 10 wrapped around a dog's neck with the dog in position for a veterinary exam or grooming procedure.

The collar 10 comprises a foam base 12 that has a front edge 14, a rear edge 16, a top edge 18 and a bottom edge 20. The top edge 18 has a relief or arcuate cut 22 that provides a comfortable fit and proper positioning around the dog's neck. The edges of the arcuate cut 22 may be tapered or flattened to reduce wear of the edges of the arcuate cut and to reduce the possibility of tearing the foam base 12. This may also be more comfortable for the dog when placed around its neck. The foam base 12 is preferably made from a polyethylene foam, preferably a four-pound crosslinked polyethylene foam.

A hook and loop fastener is used to securely wrap the collar 10 around the dog's neck. At the front edge 14 of the base 12 is a locking strap 24 with an active face 26 having loops. The locking strap 24 has a proximal end 28 that is attached to the front edge 14 of the foam base 12. A distal end 30 of the locking strap 24 is the free end. On an opposite side of the active face 26 is a non-active face 34, meaning that it has no loops on its surface.

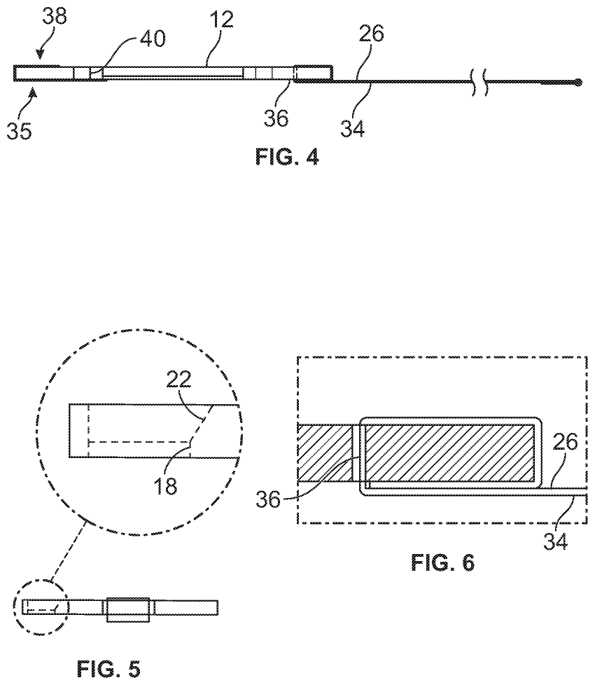

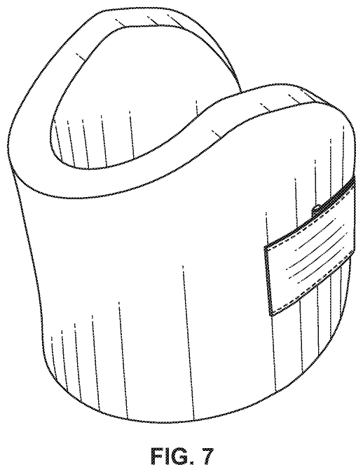

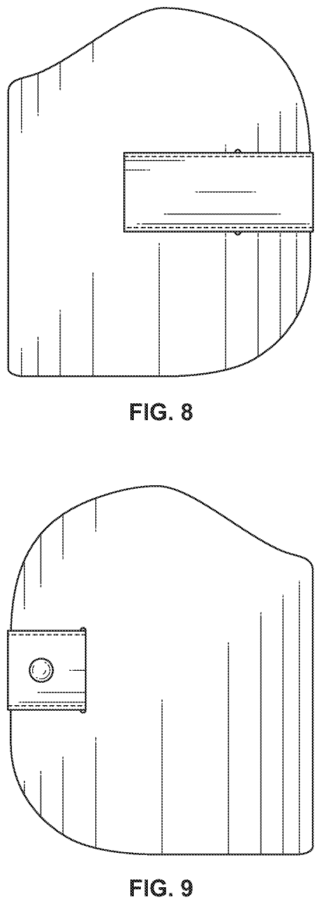

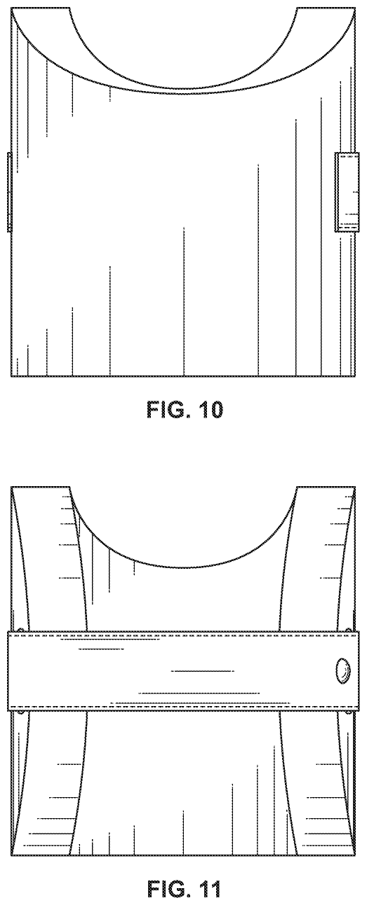

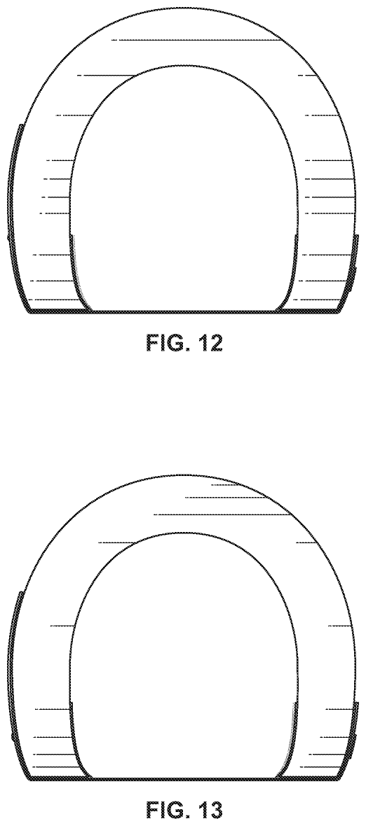

The proximal end 28 may be attached to the front edge 14 in various ways. One way is clearly illustrated in FIGS. 4 and 6. The proximal end 28 passes through a slot 36 in the front edge 14. The proximal end 14 wraps around the front edge 14 and is bonded to the foam base 12 in four locations over each if the four surfaces as seen in FIG. 6. It is also bonded with adhesive to itself on the underside of the foam base 12 so that it is adhesively bonded at five points of contact to securely secure the proximal end 28 to the front 14. Alternatively, the proximal end 28 can be fastened to the foam base 12 near the front edge 14 by means of a rivet passing through both the proximal end of the locking strap 24 and the foam base 12. Other fastening means can also be employed in order to securely attach the proximal end 28 to the foam base 12.

At the rear edge 16 of the foam base 12 is a strap or patch 35 with a hook fastener face 38. The hook fastener face 38 is exposed on the surface of the foam base 12. The hook fastener face 38 has the hooks exposed while an opposite non-active or smooth face 40 is permanently bonded with adhesive to the foam base 12. Alternatively, the strap or patch 35 may be secured to the foam base 12 by means of a rivet or similar fastener.

To use the dog collar 10 the arcuate cut 22 in the foam base 12 is placed underneath the dog's jaw and the foam base is wrapped around the dog's neck. The locking strap 24 is wrapped around the back of the dog's neck. The active face 26 having the loops is attached to the hook fastener face 38 on the strap or patch 35. This secures the collar 10 around the dog's neck and restrains movement of the dog's head during the grooming process and/or veterinary examination. Yet, the design allows the dog to breath freely and see the groomer or veterinarian which has a calming effect on the dog. Alternatively, locking strap 24 may have the hooks on its surface and the strap or patch 35 may have the loops. This merely reverses the two locking surfaces of the Velcro type fastener, but the operation is identical. To release the collar, the distal end 30 is lifted to release the loop strap 24 from the hook face 36.

The size of the foam base 12 can be varied depending on the size of the dog's neck. However, due to the adjustability of the straps, only a few sizes are necessary to accommodate all sizes of dogs. The width of the collar should be approximately the distance from beneath the jaw to the shoulder blade. The length should be sufficient to wrap around the dog's neck, but not having the front edge 14 overlapping the rear edge 16. The collar should not press on the dog's larynx and should pass under the dog's ears.

Thus, there has been provided a collar or restraint device for dogs or other animals to keep the animal from turning its head and biting the veterinarian or pet groomer when the animal is being examined, treated or groomed. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the claims.

What is claimed is:

1. A veterinary or grooming collar for restraining side to side movement of the animal's head comprising:
a foam base having a length with a front edge and a rear edge, a width with a top edge and a bottom edge,
an arcuate cut centrally disposed along the top edge of the foam base, the neck of the animal received in the arcuate cut when the front edge and rear edges are pushed toward each other thereby forming a tubular collar surrounding the neck of the animal,
fastener means mounted on the front edge and on the rear edge for connecting the front edge to the rear edge for retaining the collar around the neck of the animal,
whereby the collar restricts rotation of the animal's head when the collar is mounted around the animal's neck yet allows the animal to have its forward and peripheral vision unimpaired.

2. The veterinary or grooming collar of claim 1, wherein the arcuate cut has tapered edges for providing a comfortable edge against the animal's neck.

3. The veterinary or grooming collar of claim 1, wherein the foam base is made from polyethylene foam.

4. The veterinary or grooming collar of claim 3 wherein the polyethylene foam is a crosslinked polyethylene foam.

5. The veterinary or grooming collar of claim 1, wherein the fastener means comprises a hook and loop fastener.

6. A method for restraining the movement of an animal's head during a veterinary examination or during grooming comprising the steps of:
a. placing a foam collar around the neck of the animal, the collar having a base with a length with a front edge and a rear edge, a width with a top edge and a bottom edge, and an arcuate cut centrally disposed along the top edge of the foam base;
b. orienting the arcuate cut under the neck of the animal;
c. applying a force to the front edge and rear edge for pushing the front edge and rear edge toward each other;
d. forming a tubular collar surrounding the neck of the animal;
e. fastening the front edge and the rear edge to each other for retaining the collar around the neck of the animal;
f. restricting rotation of the animal's head when the collar is mounted around the animal's neck yet allowing the animal to have its forward and peripheral vision unimpaired.
